(19) United States
(12) Patent Application Publication
(10) Pub. No.: US 2015/0181815 A1
(43) Pub. Date: Jul. 2, 2015

(54) TREE GUARD

(71) Applicant: James Erin Saunders, Kempton, PA (US)

(72) Inventor: James Erin Saunders, Kempton, PA (US)

(21) Appl. No.: 14/144,447

(22) Filed: Dec. 30, 2013

(51) Int. Cl. A01G 13/10; B29C 51/00

(52) U.S. Cl. CPC A01G 13/10; B29C 51/00; B29K 2101/00

(57) ABSTRACT

A tree guard protects trees from deer rutting, power tools, and other animals and rodents. The tree guard wraps around a tree using a spring loaded coil that can expand as the tree grows. The tree guard is formed as a spiral piece of plastic that ensures a proper grip about the tree's bark by its spring loaded features. The tree guard has a tapered design incorporated into the plastic that allows the tree guard to grip any tree trunk, from about ¾ inch to about 4 inches. The tree guard can further include perforations formed therethrough to allow air circulation to the tree. The tree guard can include a repellent scent blended into the plastic product to provide a tree guard that not only prevents animal injury to trees, but that also repels the animals from the trees in the first place.

### BACKGROUND OF THE INVENTION

The present invention relates to a plastic tree guard and, more particularly, to plastic tree guard that prevents damage to trees from deer and power tools.

Deer rutting is a horrible environmental problem. The natural predator to deer is the mountain lion. However, in areas of high deer population, this natural predator is not around, or has reduced in numbers to not control the deer population.

Deer rutting can destroy trees. This can occur both in forests as well as on personal property. Homeowners, especially those in areas where deer are present, can have many damaged or killed trees during a single deer rutting season.

In addition to deer rutting, other animals can pose threats to trees. Rabbits and rodents can damage the bark of trees.

Conventional tree protection products have to be re-shaped or enlarged as the tree grows. Other conventional devices can seal too well, resulting in the retention of moisture, causing mold and mildew. Still other conventional devices expose gaps for deer and vermin to penetrate. Still other conventional devices, such as round cast iron fences, and be costly and may not blend well with the landscape.

As can be seen, there is a need for a device that can quickly and easily be applied to a tree to protect the tree from deer rutting, power tools and other animal or rodent damage.

### SUMMARY OF THE INVENTION

In one aspect of the present invention, a tree protection device comprises a plastic strip having a first end and a second end, the first end being a leading edge of the plastic strip, wherein the plastic strip is formed in a resiliently unwrappable wrap; and the plastic strip has a tapered spring loaded feature where the first end is urged to maintain a first diameter and the second end is urged to maintain a second, smaller diameter.

In another aspect of the present invention, a method for protecting a tree comprises unwinging a leading edge of a plastic strip from a roll, the plastic strip having a first end and a second end, the first end being the leading edge of the plastic strip, wherein the plastic strip has a tapered spring loaded feature where the first end is urged to maintain a first diameter and the second end is urged to maintain a second, smaller diameter; and wrapping the plastic strip about the tree, wherein the tapered spring loaded feature grips the tree.

In a further aspect of the present invention, a method of making a tree guard comprises extruding plastic into a strip; placing the extruded plastic strip into a water bath until it reaches a soft warm temperature; and wrapping the strip about a chilled conical mandrel to form a tree guard having a tapered spring loaded feature where a first end is urged to maintain a first diameter and a second end is urged to maintain a second, smaller diameter.

These and other features, aspects and advantages of the present invention will become better understood with reference to the following drawings, description and claims.

### BRIEF DESCRIPTION OF THE DRAWINGS

FIG. 1 is a perspective view of a tree having a tree guard wrapped therearound, according to an exemplary embodiment of the present invention;

FIG. 2 is a perspective view of a portion of the tree guard of FIG. 1, laid flat;

FIG. 3 is a detailed side view of a conical mandrel wrapped with the tree guard of the present invention, illustrating an exemplary process for the formation of the tree guard;

FIG. 4 is a cross-sectional view taken along line 4-4 of FIG. 3; and FIG. 5 is a perspective view of the tree guard of FIG. 1, illustrating the tree guard coiled prior to installation about a tree.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a tree guard that protects trees from deer rutting, power tools, and other animals and rodents. The tree guard wraps around a tree using a spring loaded coil that can expand as the tree grows. The tree guard is formed as a spiral piece of plastic that ensures a proper grip about the tree's bark by its spring loaded features. The tree guard has a tapered design incorporated into the plastic that allows the tree guard to grip any tree trunk, from about ¾ inch to about 4 inches. The tree guard can further include perforations formed therethrough to allow air circulation to the tree.

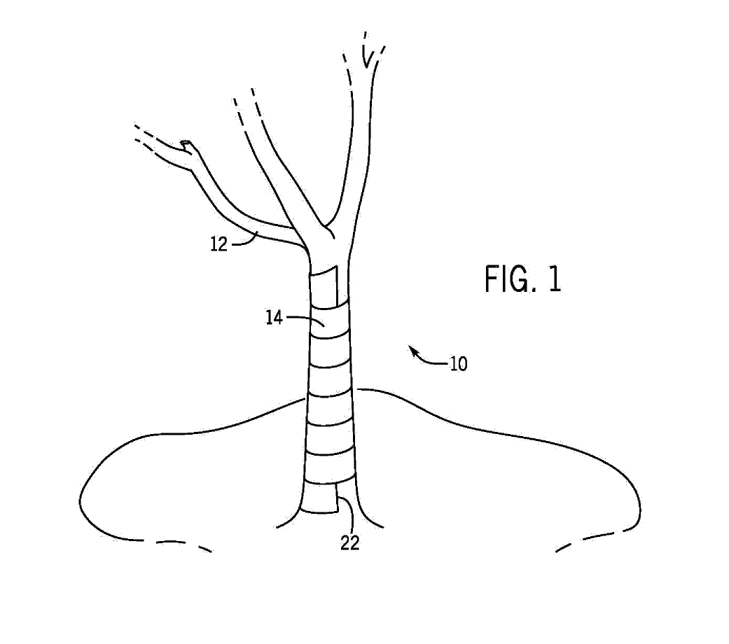

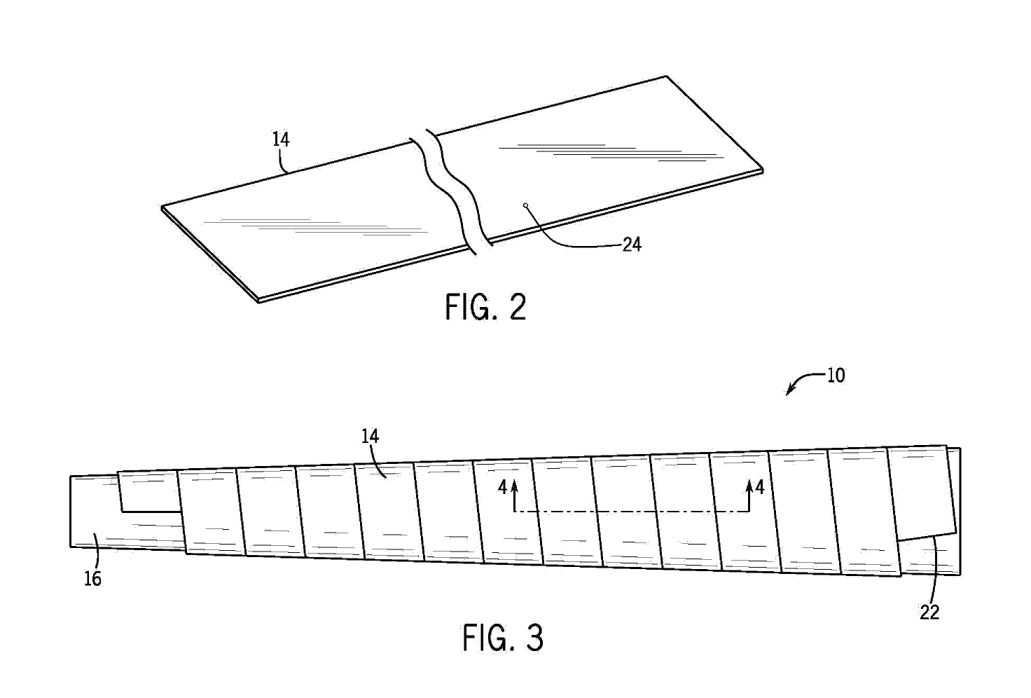

Referring to FIGS. 1 and 2, a tree 12 can be wrapped with a tree guard 10 to protect the trunk of the tree from power tools, deer rutting, and other animal or rodent damage. The tree guard can be formed from a plastic material 14 where a lead-edge 22 of the product is wrapped about the tree 12 next to the ground and the remainder of the plastic material 14 can continue about the tree 12. Typically, the tree guard 10 can reach up to about four feet from the ground. Of course, the length of the plastic material 14 can vary depending on the size of the tree.

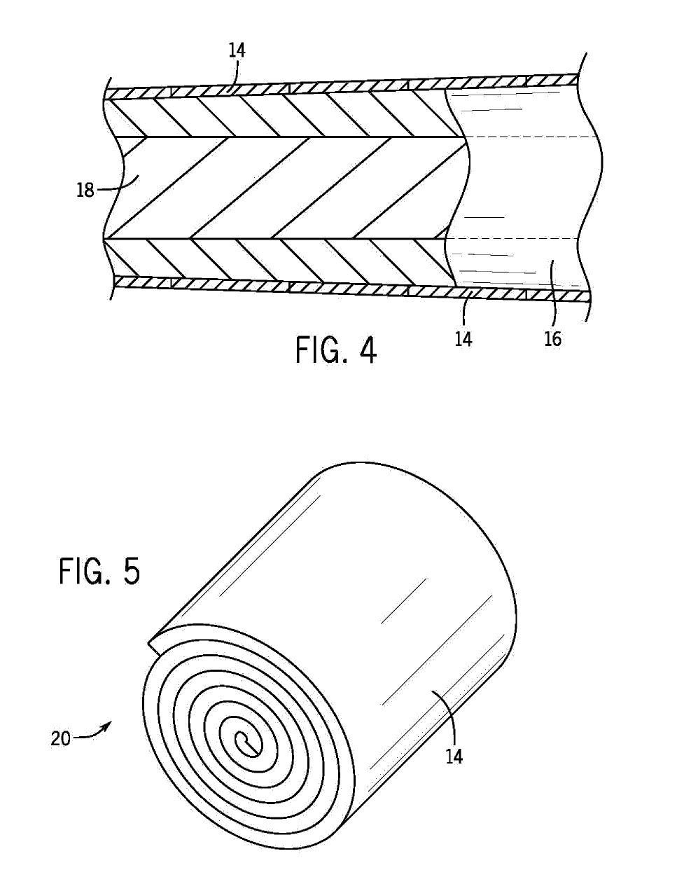

As shown in FIGS. 3 and 4, the plastic material 14 is formed by a process that provides a spring loaded feature into the resulting tree guard 10. In an exemplary manufacturing method, a plastic, such as poly vinyl chloride, is extruded into thin plastic strips, typically about 3 inches wide and about 81 to 83 inches long. This exemplary width and length may be adjusted depending upon the application. The hot plastic strips are put through a water bath until they reach a soft warm temperature. A conical mandrel 16, such as a steel mandrel filed with water 18, is frozen solid and then the warm plastic strips are wrapped around the tapered mandrel, as shown in FIG. 3, creating the shape and the spring loaded feature of the tree guard 10.

As shown in FIG. 5, the cooled plastic material 14 can be removed from the conical mandrel 16 and held together in a roll 20. The resulting plastic material 14 includes the spring loaded feature, where, when the plastic material 14 can be flexibly unrolled (for example, unrolled and rolled about a tree), the spring loaded feature causes the plastic material 14 to be urged back to its original shape (for example, that shown in FIG. 5). This feature allows the tree guard 10 to wrap around and grip the tree 12.

With this spring loaded feature, the tree guard 10 can fit and grip trees of various diameters. For example, in some embodiments, the tree guard 10 can fit a range of diameters from about ¾ inch to about 4 inches. Of course, by adjusting the side of the conical mandrel 16, the tree guard can be made for even larger or smaller trees.

In some embodiments, the plastic material 14 of the tree guard 10 can include a plurality of perforations 24 formed at various locations along the length of the tree guard 10. These perforations can be formed through various methods known in the art. For example, the perforations can be cut or drilled out of the finally formed tree guard. The perforations 24 can be spaced and sized to permit adequate air exchange under the tree guard 10 to prevent buildup of mold, mildew or the like.

To use the tree guard 10, a user simply begins at the widest end of the tree guard and unwinds the tree guard while winding about the tree. As the user unwinds the coiled tree guard and continues wrapping around the tree, the user can overlap each layer slightly as wrapping up the tree's trunk.

In some embodiments, the plastic material of the tree guard can include a non-toxic aromatic material added to a surface of the plastic material or formed with the plastic melt prior to extrusion. Regardless of method of manufacture, the resulting tree guard can be designed to not only prevent damage to trees, but also repel animals, such as deer, rabbits, or the like.

The tree guard can be formed in various colors, depending on the application and the preferences of the end user. Typically, the tree guard is formed in a color that resembles the tree's color, making the tree guard minimally visible to maximize aesthetic appeal.

While the above description refers to protection of a tree, the tree guard of the present invention may be used to protect various growth, including not only trees, but shrubs, bushes, and the like.

It should be understood, of course, that the foregoing relates to exemplary embodiments of the invention and that modifications may be made without departing from the spirit and scope of the invention as set forth in the following claims.

What is claimed is:

1. A tree protection device comprising:
a plastic strip having a first end and a second end, the first end being a leading edge of the plastic strip, wherein
the plastic strip is formed in a resiliently unwindable wrap; and
the plastic strip has a tapered spring loaded feature where the first end is urged to maintain a first diameter and the second end is urged to maintain a second, smaller diameter.

2. The tree protection device of claim 1, further comprising a plurality of perforations disposed along a length of the plastic strip.

3. The tree protection device of claim 1, further comprising a repellant scent material disposed in the plastic strip.

4. The tree protection device of claim 1, wherein the plastic strip has a width of about 3 inches and a length from about 81 to about 83 inches.

5. A method for protecting a tree, comprising:
unwrapping a leading edge of a plastic strip from a roll, the plastic strip having a first end and a second end, the first end being the leading edge of the plastic strip, wherein the plastic strip has a tapered spring loaded feature where the first end is urged to maintain a first diameter and the second end is urged to maintain a second, smaller diameter; and
wrapping the plastic strip about the tree, wherein the tapered spring loaded feature grips the tree.

6. The method of claim 5, further comprising repelling animals with the plastic strip by incorporating a repellant aroma into the plastic strip.

7. The method of claim 5, further comprising allowing air circulation to the tree through perforations formed in the plastic strip.

8. A method of making a tree guard, comprising:
extruding plastic into a strip;
placing the extruded plastic strip into a water bath until it reaches a soft warm temperature; and
wrapping the strip about a chilled conical mandrel to form a tree guard having a tapered spring loaded feature where a first end is urged to maintain a first diameter and a second end is urged to maintain a second, smaller diameter.

9. The method of claim 8, further comprising filling the conical mandrel with water and freezing the water to form the chilled conical mandrel.

10. The method of claim 8, further comprising unwrapping a chilled strip from the conical mandrel and wrapping into a roll.
